(19) United States
(12) Patent Application Publication
(10) Pub. No.: US 2026/0138555 A1
(43) Pub. Date: May 21, 2026

(54) RETAINING ARRANGEMENT FOR AN AIRBAG ARRANGEMENT, METHOD FOR PRODUCING SUCH A RETAINING ARRANGEMENT, AND AIRBAG ARRANGEMENT

(71) Applicant: Faurecia Innenraum Systeme GmbH, Hagenbach (DE)

(72) Inventor: Matthias KUNTZ, Herxheim (DE)

(21) Appl. No.: 19/392,824

(22) Filed: Nov. 18, 2025

(30) Foreign Application Priority Data
Nov. 20, 2024 (DE) 10 2024 211 137.6

(51) Int. Cl. B60R 21/235

(52) U.S. Cl. CPC B60R 21/235; B60R 2021/23571

(57) ABSTRACT

A retaining arrangement for an airbag arrangement configured to apply a holding force to at least one component of the airbag arrangement can comprise a retaining element with at least one loop region in which at least two subsections of the retaining element abut against each other. The retaining arrangement can further comprise at least one fastening arrangement which fastens the at least two subsections to one another and which extends along a longitudinal axis in the at least one loop region. A local tensile strength of the at least one fastening arrangement when viewed along the longitudinal axis increases, at least in some sections, between a first outermost end region and a second outermost end region.

### CLAIM FOR PRIORITY

This application claims the benefit of priority of German Application No. 10 2024 211 137.6, filed Nov. 20, 2024, which is hereby incorporated by reference in its entirety.

### TECHNICAL FIELD

The present disclosure relates to a retaining arrangement for an airbag arrangement, to a method for producing such a retaining arrangement, and to an airbag arrangement.

### BACKGROUND

Some airbag arrangements, particularly those used in road vehicles, use retaining arrangements to generate holding forces for components of the airbag arrangement.

For example, airbag arrangements can include airbag covers with a firing channel underneath with an airbag located in the firing channel. In such arrangements, when the airbag is deployed, it first unfolds in the direction determined by the firing channel and presses on the airbag cover, at which point the airbag cover opens and the airbag can unfold in the vehicle interior.

In some arrangements, for example as discussed in EP 2 096 006 B1 one or more retaining elements can be used in order to generate a defined holding force on an airbag cover when the airbag is deployed. In this way, the opening behavior of the airbag cover can be defined. In particular, this allows a rotational movement of the airbag cover to be reliably initiated and can reduce the risk of a predominantly lifting load that lifts the lifting cover, but does not rotate it.

### SUMMARY

It has been recognized that there is still further potential for improvement in defining the opening behavior of an airbag arrangement. The present disclosure is therefore directed at the object of providing possibilities for improving the definition of such an opening behavior.

This object is achieved by the subject matter of the appended independent claims. Advantageous further developments are specified in the dependent claims, in this description, and in the figures.

Accordingly, a retaining arrangement for an airbag arrangement is proposed, wherein the retaining arrangement is configured to apply a holding force to at least one component of the airbag arrangement, wherein the retaining arrangement comprises an in particular planar retaining element with at least one loop region in which at least two subsections, in particular of the surface of the retaining element, abut against each other; and wherein the retaining arrangement comprises at least one fastening arrangement which fastens the subsections to one another and which extends along a longitudinal axis in the loop region. In this case, a local tensile strength of the fastening arrangement when viewed along the longitudinal axis increases, at least in some sections, between a first outermost end region, in particular an axially outermost end region, and a second outermost end region, in particular an axially outermost end region.

The component of the airbag arrangement to which a holding force is to be applied may, in particular, be a component that is movable at the latest when the airbag is deployed, and in particular an airbag cover. The retaining arrangement can be connected to the movable component at a first end and in particular can be fastened directly thereto. At another end, the retaining arrangement can be connected to an immovable component and in particular can be fastened directly to it. The loop region disclosed here may be located between this first end and the other end. It may generally be non-fastened to a further component, in particular non-fastened to a movable or immovable component of the airbag arrangement.

The retaining element may in particular comprise a fabric or a film, or consist of such a fabric or such a film. The film may, for example, comprise polyester and in particular fiber-reinforced polyester and/or aramid. The fabric may, for example, comprise polyester and/or aramid fibers.

The subsections of the loop arrangement can extend parallel to one another and/or run along the longitudinal axis. They can merge into one another—for example, in a curved region or apex region of the loop region. Such a curved region or apex region can, for example, form a region of the loop region that protrudes furthest relative to an adjacent surface of the retaining element, in particular at least when the retaining element is not yet installed in an airbag arrangement. In general, the loop region can protrude locally from a surface and/or plane of the in particular planar retaining element, in particular orthogonally thereto. This can also apply in particular at least if the retaining element is not yet installed in an airbag arrangement.

The arrangement of the subsections in the loop region can correspond to an overlapping arrangement of the subsections and/or can be such that they are opposite one another. According to one variant, the subsections are of equal size, particularly in relation to their respective surface areas. The loop region can correspond to a folded region of the otherwise planar retaining element or can be created by a corresponding local folding.

The subsections and/or the loop region can extend over a complete dimension of the retaining element, in particular viewed along the longitudinal axis. This could, for example, be a width of the retaining element. Along a dimension extending at an angle to the loop region and/or the longitudinal axis, e.g., viewed along a length of the retaining element, the loop region can, for example, be positioned substantially centrally. In particular, the loop region can be spaced apart from end regions of the retaining element along this dimension by at least 10% and further preferably by at least 20% of the corresponding dimensions.

In principle, the subsections can be fastened together using the fastening arrangement by means of any suitable joining method. Examples include gluing or welding. According to an advantageous further development, this is done by sewing the subsections, wherein the fastening arrangement can comprise at least one seam. By designing and/or selecting the material of the seam, an in particular defined strength and in particular tensile strength of the fastening arrangement can be achieved.

In the outermost end regions, the fastening arrangement may generally be reinforced and/or have increased tensile strength. In particular, any seam (or other joining connection) comprised by the fastening arrangement can be reinforced in the end regions. In the case of a seam, this can be done, for example, by locking or otherwise securing, wherein the locking can, for example, comprise sewing a selected, shared axial subregion of the subsections multiple times. In other words, this shared subregion can be oversewn multiple times, in particular by repeatedly sewing back and forth within this subregion and/or along the longitudinal axis. Viewed along the longitudinal axis following the axially outer end regions, the seam may be designed to be less strong, at least in some sections—for example, by sewing exclusively in one direction along the longitudinal axis.

The seam may generally comprise a fiber or a yarn. It can optionally be made of the same material as the fabric or of a material with a preferably lower tensile strength than the material of the fabric.

According to the present disclosure, the mentioned increase in tensile strength along the longitudinal axis is also provided outside the outer end regions. This increase can in particular occur in a region-by-region manner, i.e., in a defined region within the longitudinal axis, such that the tensile strength can be reduced axially before and/or after this region.

In this way, the fastening arrangement can be specifically reinforced outside the outermost end regions and/or between them. This provides an additional degree of design freedom to define the strength and resulting tear behavior/failure behavior of the fastening arrangement. Without such an intermediate reinforcement of the fastening arrangement along the longitudinal axis in the form of an intermediate increase in its tensile strength, it may, under certain circumstances, tear at any point along its length. This cannot always guarantee the desired opening behavior of an airbag arrangement, since the holding force generated by the retaining arrangement can then be reduced prematurely.

According to a further development, the increase occurs, at least in some sections, up to a maximum local tensile strength of the fastening arrangement and/or up to at least 60% of a maximum local tensile strength of the fastening arrangement. Axially before and/or after such a localized increase, the local tensile strength of the fastening arrangement may, for example, correspond to not more than 60% or even not more than 40% of a maximum local tensile strength of the fastening arrangement.

According to a further development, a tensile strength of the first outermost end region and/or of the second outermost end region corresponds to a maximum local tensile strength of the fastening arrangement and/or at least 60% of a maximum local tensile strength of the fastening arrangement.

In general, the tensile strength of a fastening arrangement can be measured under a tensile load transverse to any seam and/or longitudinal axis. The tensile force can, for example, be applied centrally or at multiple locations along the longitudinal axis. Different values for the local tensile strength can occur along the longitudinal axis, e.g., depending upon the local implementation of the tensile strength. Regions with low tensile strength may fail before regions with comparatively higher tensile strength. Regions with maximum tensile strength can withstand loads for the longest time.

According to a further development, the subsections outside the fastening arrangement and in particular at least along the longitudinal axis are not connected or are at least not sewn. In other words, the fastening arrangement can form the only direct fastening of the subsections viewed along the longitudinal axis, or at least the only seam connection of the subsections. Any regions of the subsections outside the fastening arrangement may be regions that, viewed along the longitudinal axis, are located before and/or after the outermost end regions of the fastening arrangement. Alternatively or additionally, this may concern regions that run parallel to the fastening arrangement, but in which the subsections are preferably not directly fastened to one another.

According to a variant, the fastening arrangement extends along the entire longitudinal axis of the subsections and/or the loop region or along at least 75% of this longitudinal axis, and in particular at least 90%.

According to a further development, the fastening arrangement comprises at least one seam by means of or via which the subsections are fastened to one another and in particular are fastened directly to one another by directly sewing the subsections with this seam. In one variant, the fastening arrangement can comprise multiple and in particular parallel seams, at least in some sections along the longitudinal axis. Alternatively or additionally, the fastening arrangement may comprise only a single seam, at least in some sections along the longitudinal axis. Any of the seams mentioned here can run along the longitudinal axis.

According to a further development, the fastening arrangement is formed continuously between the first outermost end region and the second outermost end region. For example, a connection of the subsections produced in this way can be continuous between the first and the second outermost end regions, but with the aforementioned intermediate variations and in particular an intermediate increase in the tensile strength caused by the fastening arrangement.

According to a further development, the fastening arrangement, despite its continuous design, does not fasten the subsections directly to one another, at least in some sections. This may be the case, for example, if the fastening is designed as a seam, wherein a material of the seam, e.g., a yarn or a fiber, is present continuously along the longitudinal axis. However, the seam or its material in some sections may not be used to directly sew the subsections together. For example, this material may be guided along the subsections and in particular can rest on at least one of them, but may not sew them directly together.

In this way, for example, a deliberately non-fastened region of the subsections with reduced tensile strength can be created. Embodiments of the present disclosure provide that such non-fastened regions be delimited at least at one end by one of the mentioned outermost end regions and/or an intermediate end region explained below with correspondingly increased tensile strength.

According to a further development, the fastening arrangement is interrupted at least in some sections. In the interrupted sections, the subsections of the retaining element may not be directly fastened to one another by the fastening arrangement or in any other way. If the fastening arrangement comprises a seam, in contrast to the embodiment discussed above, the seam material in an interrupted configuration cannot be passed over and/or through and/or along the corresponding interrupted sections of the fastening arrangement.

According to a further development, an interrupted section of the fastening arrangement has a shorter length measured along the longitudinal axis than sections, adjacent to it on both sides, of the fastening arrangement. For example, the length may be less than 75%, less than 50%, or even less than 25% of the length of the adjacent sections.

According to a further development, the uninterrupted sections of the fastening arrangement adjacent to the interrupted section each have an intermediate end region which has a maximum local tensile strength of the fastening arrangement and/or at least 60% of a maximum local tensile strength of the fastening arrangement. The intermediate regions may be formed according to any of the examples of the outermost end regions of the fastening arrangement mentioned here. In the case of a seam, these may, for example, include appropriately locked and/or secured seam ends. In this way, for example, a sequence of seam regions with increased tensile strength can be created along the longitudinal axis, even outside and/or between axially outermost end regions in the fastening arrangement.

The present disclosure also relates to an airbag arrangement comprising:
an airbag and at least one component that moves at the latest when the airbag is deployed, such as an airbag cover.
a retaining arrangement according to any of the aspects disclosed herein,
   wherein the retaining arrangement is configured to apply a holding force to the movable component of the airbag arrangement.

The present disclosure also relates to a method for producing a retaining arrangement, wherein the retaining arrangement comprises an in particular planar retaining element and is configured to apply a holding force to at least one component of the airbag arrangement, wherein the method comprises:
placing two subsections together, in particular of the surface of the retaining element, to form a loop region; and
fastening the subsections to each other by means of or using a fastening arrangement extending along a longitudinal axis,
   wherein a local tensile strength of the fastening arrangement when viewed along the longitudinal axis increases, at least in some sections, between a first outermost end region and a second outermost end region.

The method may generally be designed for producing a retaining arrangement according to any aspect disclosed herein. In particular, the method may comprise any further features and/or measures for producing any retaining arrangement according to any aspect disclosed herein.

In general, disclosures and/or variants disclosed in the discussion of the retaining arrangement may also apply to identical features of the airbag arrangement and/or the method, and vice versa.

Exemplary embodiments of the present disclosure are described below with reference to the accompanying schematic figures. The same reference signs can be used for comparable features across all figures.

### BRIEF DESCRIPTION OF DRAWINGS

FIG. 1 shows a perspectival view of a retaining arrangement according to a first embodiment.

FIG. 2 shows a side view of the retaining arrangement of FIG. 1.

FIG. 3 shows a perspectival view of a retaining arrangement according to a second embodiment.

FIG. 4 shows a diagram illustrating a holding effect that can be achieved using a retaining arrangement according to the present disclosure.

FIG. 5 shows a diagram comparable to FIG. 4 but using a retaining arrangement with a continuous, non-reinforced fastening arrangement.

### DETAILED DESCRIPTION

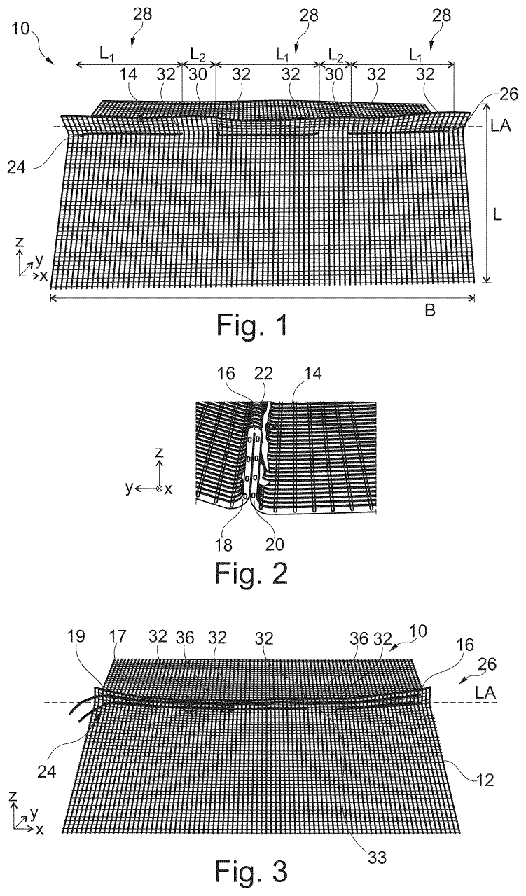

FIG. 1 shows a retaining arrangement 10 according to a first exemplary embodiment of the present disclosure. The retaining arrangement 10 comprises a substantially planar retaining element 12 and a fastening arrangement 14 explained in detail below. The retaining arrangement 10 is in a state in which it is not yet installed in an airbag arrangement.

The planar retaining element 12 is a fabric and/or a mesh-like structure and may comprise materials according to any examples disclosed herein. The generally planar extension of the retaining element 12 may be interrupted only locally by the loop region 16 explained below.

The retaining element 12 has a width dimension B which extends along the x-axis of the illustrated coordinate system. The retaining element 12 also has a length dimension L that extends along the y-axis of the illustrated coordinate system. The width dimensions B and length dimension L span the surface of the retaining element 12.

For example, centrally along the length dimension L, the retaining element 12 comprises a loop region 16. This extends over the entire width dimension B. As is clear from the side view in FIG. 2, two subsections 18, 20 of the retaining element 12 are arranged adjacent to one another in the loop region 16 and run parallel to one another. In particular, common outer sides of the subsections 18, 20 (in FIG. 2, for example, outer sides located below or also inside) are arranged opposite one another and in direct contact with one another. The subsections 18 and 20 can also be described as overlapping. In a transition region 22, which forms an apex region of the loop region 16, the subsections 18, 20 merge into one another. In the example shown, the subsections 18 and 20 are dimensioned similarly and, in particular, have identical surface areas.

At least in the state shown and not yet installed in an airbag arrangement, the loop region 16 protrudes relative to the surface or plane of the adjacent planar regions of the retaining element 12.

The subsections 18, 20 are fastened to one another and held together by the fastening arrangement 14. In the example shown, this fastening is effected by seams of the fastening arrangement 14, i.e., the subsections 18, 20 are sewn together by the fastening arrangement 14, forming the loop region 16.

In FIG. 1, a longitudinal axis LA is marked, along which the loop region 16 including the fastening arrangement 14 extends. This longitudinal axis LA runs, for example, along and in particular parallel to the width dimension B. It is shown that the fastening arrangement 16, viewed along this longitudinal axis LA, has a first outermost end region 24 and a second outermost end region 26. These end regions 24, 26 are formed at opposite outermost axial ends of the fastening arrangement 16. They optionally are at a distance from the outermost axial ends of the loop region 16 with respect to the longitudinal axis LA.

According to an optional variant, each seam within the end region 24, 26 is reinforced and in particular locked. This involves sewing back and forth multiple times over a limited distance of, for example, less than 10 cm and in particular less than 5 cm in the same section along the longitudinal axis LA. In this way, the local tensile strength of the fastening arrangement 14, in particular for tensile loads along the length dimension L of FIG. 1, is increased within the outermost end regions 24, 26. In particular, there is where maximum values of the local tensile strength occur in relation to the entire fastening arrangement 14.

The fastening arrangement 14 of FIG. 1 has sections 28 with a fastening-effective seam axially between the end regions 24, 26. Axially between each pair of such fastening-effective sections 28, there are interrupted sections 30 without a seam. Axially adjacent to each interrupted section 30, the adjacent connecting-effective sections 28 in turn have intermediate end regions 32 which, analogously to the outermost end regions 24, 26, have reinforced seam sections, in particular locked seam sections, with locally increased tensile strength.

In the example shown, the intermediate end regions 32 each have substantially the same maximum local tensile strengths as the axially outermost end regions 24, 26.

Axially adjacent to each intermediate end region 32, and also on the axially outermost end regions 24, 26, the seams within the fastening-effective sections 28 are not locked. They therefore have a correspondingly reduced local tensile strength, e.g., a tensile strength reduced by at least 40% or by at least 60% or by at least 75% compared to the maximum local tensile strength.

It should be noted that the intermediate end regions 32 have a length L1 along the longitudinal axis LA which is greater than the interrupted sections 30 (see their length L2), and in particular a length L1 which is at least twice as great.

Along the longitudinal axis LA, the fastening arrangement 14 is thus characterized by an interim increase in the local tensile strength within each intermediate end region 32. If the loop region 16 is subjected to a tensile load, particularly in the y-direction according to FIG. 1, the fastening arrangement 28 can thus withstand high local tensile forces both in the axially outer end regions 24, 26 and within the intermediate end regions 32. In this way, an uncontrolled tearing of the at least one seam of the fastening arrangement 14 along the longitudinal axis LA and/or a forced initial tearing of the fastening arrangement 14 between the outermost end regions 24, 26 can be prevented.

It has been shown that this reliably initiates a rotational movement of an airbag cover coupled to the retaining arrangement 10, and that a purely lifting load which acts predominantly without rotation can be avoided.

The interrupted sections 30 can, as a further degree of freedom, enable a deliberate axial weakening of the fastening arrangement 14 along the longitudinal axis LA. Additionally or alternatively, these enable a low-effort production of the adjacent, locked, intermediate end regions 32. They can thus be considered a result of the production of these specifically reinforced intermediate end regions 32.

FIG. 3 shows a further embodiment of a retaining arrangement 10 according to an exemplary embodiment of the present disclosure. This embodiment is largely analogous to that of FIG. 1. One difference is that the fastening arrangement 14 generally comprises two seams 17, 19 running parallel to one another and optionally interrupted in certain sections. These in turn run along a longitudinal axis LA of a loop region 16. These seams 17, 19 are in principle of the same design and have correspondingly locked and thus axially outermost end regions 24, 26 reinforced with regard to the local tensile strength. They also have axially similarly positioned, locked intermediate end regions 32 which are therefore reinforced with regard to local tensile strength, as explained above.

In contrast to the variant of FIG. 3, a complete interruption of the seams 17, 19 is, optionally, not always provided axially between each pair of intermediate end regions 32 of each seam 17, 19. Instead, sections 36 are formed there which are partly ineffective for fastening and in which the seam material, in particular a yarn, thread, or fiber, is continued, but without sewing the two subsections 18, 20 of the loop region 16 together.

Instead, the seam material can, for example, be guided along and/or rest on only a single, outwardly facing outer side of the subsections 17, 19. The fastening arrangement 14 and, more precisely, the respective seams 17, 19 thereof can thus be formed without interruption. However, by forming the intermediate end regions 32, the local tensile strength is still increased in certain regions at positions that lie axially between the outermost end regions 24, 26. A possible length extension of the intermediate end regions 32 is shown circled in FIG. 3 for exemplary cases. Even if not shown separately, at least selected intermediate end regions 32 of the seams 17, 19 can be provided at mutually identical axial positions, i.e., opposite one another and/or one above the other.

It should be noted that the formation of such non-fastening-effective sections 36 can also be provided in the variant of FIG. 1 with only a single seam. Likewise, in a variant with multiple parallel seams 17, 19 according to FIG. 3, a complete interruption of these seams 17, 19 can be provided analogously to the interrupted sections 30 of FIG. 1 (see, for example, a subsection 33 of the lower seam in FIG. 3).

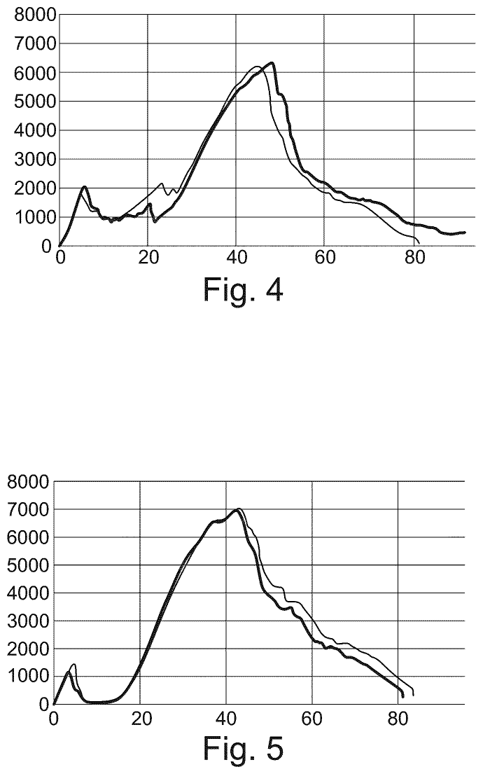

FIG. 4 shows a measurement diagram to illustrate the holding effect of a retaining arrangement 10 according to the present disclosure, which is designed, for example, according to any of the embodiments of FIGS. 1-3. Along the vertical axis, an opening force is plotted in Newtons. This force acts upon a moving component of an airbag arrangement when an airbag is deployed. This component is coupled to the retaining arrangement 10 and is held and secured by it—in particular, against resistance-free movement and/or opening. A displacement path of this moving component is plotted in millimeters along the horizontal axis.

FIG. 4 and also FIG. 5 each show two measurement curves as examples; these have been plotted for different embodiments of the present disclosure.

FIG. 4 shows that the opening force increases rapidly to approximately 2,000 N for small displacement paths. It then drops slightly, but remains at a value of over 1,000 Newtons up to a displacement path of more than 20 mm. Only then does an increase to over 6,000 Newtons up to a displacement path of approximately 45 mm occur, followed by a significant drop to below 1,000 N.

This force curve results from the fact that the generally flexible retaining arrangement 10 becomes tight until the first increase to approximately 2,000 Newtons. Only then does the fastening arrangement 14 begin to tear open successively in certain regions. More precisely, the forces are at least partially absorbed by the tightened retaining arrangement 10 and especially by means of the fastening arrangement 14, so that the movable component is opened in a controlled and less explosive manner. This is reflected in the drop in force between the initial increase to approximately 2,000 Newtons and the displacement path of up to approximately 30 mm. The subsequent continuous increase in the opening force results from a complete tearing open of the fastening arrangement 14, including in its reinforced intermediate end regions 32. As a result of this tearing, the subsections 16, 18 of FIGS. 1-3 are separated from each other and are thus available as additional excess lengths without any direct holding effect. The resulting subsequent drop in opening force also results from the reduction in the overall forces generated in connection with the deployment of the airbag.

FIG. 5 shows a diagram basically comparable to FIG. 4, but for a variant of a retaining arrangement using a continuous, non-reinforced fastening arrangement. In this case, a fastening arrangement is positioned in principle analogously to the fastening arrangement 14 disclosed herein but does not include any intermediate end regions that are axially reinforced in some regions. Instead, in this case, a simple, continuous seam without separate regional reinforcements is provided between the outer end regions of a fastening arrangement.

In this case, too, there is an initial rapid increase in the opening force, but only to approx. 1,000 N. This is followed by a rapid, complete decrease to 0 N, before a continuous increase to a maximum opening force of approx. 7,000 N with a displacement path of just over 40 mm takes place.

First of all, it is noticeable that, compared to FIG. 4, the initial increase occurs only to a lower value of 1,000 N. A maximum initial resistance or a maximum initial tensile strength of the fastening arrangement is therefore less pronounced than in the example of FIG. 4.

In contrast to FIG. 4, this initial increase to approximately 1,000 N is immediately followed by the aforementioned complete decrease to 0 N. This results from an early, complete tearing of the fastening arrangement with a continuous seam without intermediate reinforcement. The energy absorption by this fastening arrangement is therefore significantly lower than in the embodiment according to the present disclosure shown in FIG. 4. The holding effect on the moving component of the airbag arrangement is also correspondingly low, so that its opening movement can be controlled less reliably and to a lesser extent.

Not shown separately in the figures is an airbag arrangement in which a retaining arrangement 10 according to FIGS. 1-3 is installed. By way of example, reference is made to EP 2 096 006 B1 mentioned at the outset, and the differently sewn retaining means 1, 1′shown there in FIGS. 3a, 3b. These retaining means 1, 1′could in principle be replaced by a retaining arrangement 10 disclosed here, i.e., by planar retaining elements 12 of the type disclosed here together with a fastening arrangement 14 designed according to the present disclosure, in order to form an airbag arrangement according to the present disclosure. All other components in FIGS. 3a and 3b of EP 2 096 006 B1 can optionally be retained unchanged.

What is claimed is:

1. A retaining arrangement for an airbag arrangement, wherein the retaining arrangement is configured to apply a holding force to at least one component of the airbag arrangement, wherein the retaining arrangement comprises:
a retaining element with at least one loop region in which at least two subsections of the retaining element abut against each other; and
at least one fastening arrangement configured to fasten the at least two subsections to one another and which extends along a longitudinal axis in the at least one loop region, wherein a local tensile strength of the at least one fastening arrangement when viewed along the longitudinal axis increases, at least in some sections, between a first outermost end region and a second outermost end region.

2. The retaining arrangement according to claim 1, wherein the increase occurs to at least one of: i) a maximum local tensile strength of the at least one fastening arrangement or ii) at least 60% of a maximum local tensile strength of the at least one fastening arrangement.

3. The retaining arrangement according to claim 1, wherein a local tensile strength of at least one of the first outermost end region or the second outermost end region corresponds to at least one of: i) a maximum local tensile strength of the at least one fastening arrangement or ii) at least 60% of a maximum local tensile strength of the at least one fastening arrangement.

4. The retaining arrangement according to claim 1, wherein the at least two subsections outside the at least one fastening arrangement are not connected, or are not sewn.

5. The retaining arrangement according to claim 1, wherein the at least one fastening arrangement comprises at least one seam that fastens the at least two subsections to one another.

6. The retaining arrangement according to claim 1, wherein the at least one fastening arrangement is formed continuously between the first outermost end region and the second outermost end region.

7. The retaining arrangement according to claim 6, wherein the at least one fastening arrangement does not fasten the at least two subsections directly to one another, at least in some sections.

8. The retaining arrangement according to claim 1, wherein the at least one fastening arrangement is interrupted at least in some sections.

9. The retaining arrangement according to claim 8, wherein at least one interrupted section of the at least one fastening arrangement has a shorter length measured along the longitudinal axis than sections, adjacent thereto on both sides, of the at least one fastening arrangement.

10. The retaining arrangement according to claim 9, wherein one or more uninterrupted sections of the at least one fastening arrangement adjacent to the at least one interrupted section each have an intermediate end region which has at least one of: i) a maximum local tensile strength of the at least one fastening arrangement or ii) at least 60% of a maximum local tensile strength of the at least one fastening arrangement.

11. An airbag arrangement comprising:
an airbag;
at least one movable component that is movable at the latest when the airbag is deployed; and
a retaining arrangement comprising:
a retaining element with at least one loop region in which at least two subsections of the retaining element abut against each other; and
at least one fastening arrangement configured to fasten the at least two subsections to one another and which extends along a longitudinal axis in the at least one loop region, wherein a local tensile strength of the at least one fastening arrangement when viewed along the longitudinal axis increases, at least in some sections, between a first outermost end region and a second outermost end region, and wherein the retaining arrangement is configured to apply a holding force to the at least one movable component of the airbag arrangement.

12. A method for producing a retaining arrangement, wherein the retaining arrangement comprises a retaining element and is configured to apply a holding force to at least one component of an airbag arrangement, the method comprising:
placing two subsections of the retaining element together to form a loop region; and
fastening the two subsections to one another using a fastening arrangement extending along a longitudinal axis, wherein a local tensile strength of the fastening arrangement, when viewed along the longitudinal axis, increases, at least in some sections, between a first outermost end region and a second outermost end region of the fastening arrangement.
